(19) United States
(12) Patent Application Publication
(10) Pub. No.: US 2023/0344632 A1
(43) Pub. Date: Oct. 26, 2023

(54) DISTRIBUTED REGISTRATION AND AUTHENTICATION VIA THRESHOLD SECRET SHARING AND ADDITIVELY HOMOMORPHIC ENCRYPTION

(71) Applicant: VMware, Inc., Palo Alto, CA (US)

(72) Inventors: Avishay Yanai, Herzliya (IL); Alex Markuze, Herzliya (IL); Igor Golikov, Herzliya (IL)

(21) Appl. No.: 17/727,400

(22) Filed: Apr. 22, 2022

(51) Int. Cl. H04L 9/32; H04L 9/00; H04L 9/08

(52) U.S. Cl. CPC H04L 9/32; H04L 9/008; H04L 9/085; H04L 2209/46

(57) ABSTRACT

Techniques for implementing distributed registration and authentication via threshold secret sharing and additively homomorphic encryption are provided. A threshold secret sharing scheme is a cryptographic method for sharing a secret among N parties in a manner that requires at least T+1 of the N parties to cooperate in order to reconstruct/reveal the secret, where T is some threshold value less than N. Additively homomorphic encryption is an encryption scheme that enables users to perform additive computations on encrypted data without first decrypting that data. With these techniques, a group of N nodes can efficiently perform distributed registration and authentication in a correct, secure, and privacy-preserving fashion, even if up to T of the N nodes are corrupted by an adversary.

### CROSS-REFERENCES TO RELATED APPLICATIONS

The present application is related to commonly owned U.S. patent application Ser. No. 17/543,513 filed Dec. 6, 2021 and entitled “Distributed Registration and Authentication via Threshold Secret Sharing,” The entire content of this related application is incorporated herein by reference for all purposes.

### BACKGROUND

Unless otherwise indicated, the subject matter described in this section is not prior art to the claims of the present application and is not admitted as being prior art by inclusion in this section.

Computing systems that provide applications/services to clients (e.g., email systems, social media platforms, Software-as-a-Service (SaaS) systems, etc.) typically implement (1) a registration procedure that enables new clients to submit registration requests and thereby register themselves with the system, and (2) an authentication procedure that enables registered clients to submit authentication requests and thereby authenticate themselves (or in other words, login) to the system. Among other things, these registration and authentication procedures allow different clients to be associated with different privileges, preferences, persistent state, and so on with respect to the provided applications/services.

In scenarios where each registration and authentication request submitted by a client is processed independently by a single machine (i.e., node) of the computing system (referred to herein as “single-node registration and authentication”), the implementation of (1) and (2) is straightforward. For example, with respect to (1), a node can receive a registration request from a new client that includes an email address and password; transmit some secret information (e.g., a verification code) in an email to the submitted email address; receive the secret information back from the client, thereby verifying that the client is the owner of the email address; and create a registration entry for the client comprising the email address and password (or a hash of the password). With respect to (2), a node can receive an authentication request from a client that includes an email address and password; check whether the submitted password matches the password included in a registration entry keyed by the submitted email address; and if this check is successful (which indicates that the client has been successfully authenticated), grant the client access to the system.

Unfortunately, single-node registration and authentication is vulnerable to attacks by adversaries and is generally unable to guarantee correctness, security, or privacy for the registration and authentication procedures if just one node becomes corrupted. As used herein, the property of correctness means that honest (i.e., uncorrupted) clients can successfully complete registration and authentication, the property of security means that dishonest clients cannot login to the system using the passwords/credentials of other clients (or as non-registered clients), and the property of privacy means that the passwords/credentials of honest clients cannot be obtained by the adversary.

For example, assume there are three nodes S₁, S₂, and S₃ that each implement single-node registration and authentication and an adversary A corrupts (i.e., takes control of) S₁, while leaving S₂ and S₃ uncorrupted. In this scenario, because each node handles registration and authentication requests independently of the others, adversary A has free reign to censor clients (or other words, prevent clients from registering and authenticating) through S₁, impersonate clients (or in other words, login to the system using the passwords/credentials of other clients) through S₁, and perform other problematic actions, such as initiate an offline brute-force attack to try and obtain the plaintexts of hashed client passwords.

### BRIEF DESCRIPTION OF THE DRAWINGS

FIG. 1 depicts an example environment according to certain embodiments.

FIG. 2 depicts a distributed registration workflow according to certain embodiments.

FIG. 3 depicts a distributed authentication workflow according to certain embodiments.

FIG. 4 depicts another distributed registration workflow according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

The present disclosure is directed to techniques for implementing distributed registration and authentication, or in other words the collaborative processing of client registration and authentication requests by multiple nodes in a computing system. In one set of embodiments these techniques leverage threshold secret sharing, which is a cryptographic method for sharing a secret among N parties in a manner that requires at least T+1 of the N parties to cooperate in order to reconstruct/reveal the secret, where T is some threshold value less than N. An example of such a scheme is Shamir's secret sharing. In another set of embodiments these techniques also leverage additively homomorphic encryption, which is a type of encryption that enables users to perform additive computations on encrypted data without first decrypting that data.

With the techniques of the present disclosure, a group of N nodes can efficiently perform distributed registration and authentication in a correct, secure, and privacy-preserving fashion, even if up to T of the N nodes are corrupted by an adversary (subject to certain constraints on T and the nature of the network interconnecting the nodes and clients). These and other aspects are described in further detail below.

### 2. Example Environment and High-Level Solution Design

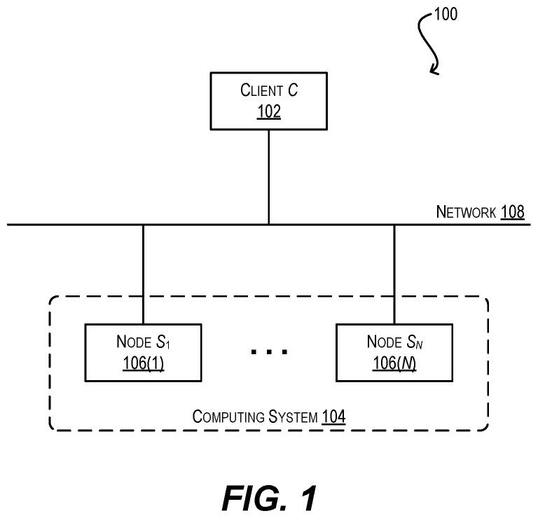

FIG. 1 depicts an example environment 100 in which embodiments of the present disclosure may be implemented. As shown, environment 100 includes a client C (reference numeral 102) that is communicatively coupled with a computing system 104 comprising N nodes S₁, . . . , S_{N} (reference numerals 106(1)-(N)) via a network 108. Generally speaking, the goal of nodes S₁, . . . , S_{N}—each of which may be any type of physical or virtual machine known in the art—is to register and authenticate clients like client C that wish to interact with computing system 104. Ideally, nodes S₁, . . . , S_{N} should implement these registration and authentication procedures in a manner that ensures correctness, security, and privacy in the face of attacks by an adversary.

As noted in the Background section, according to one approach known as single-node registration and authentication, each node S₁ can handle client registration and authentication requests independently. For example, if node S₁ receives a registration request from client C, S₁ can process that registration request in its entirety without any interaction or communication with other nodes. Similarly, if node S₂ receives an authentication request from client C after it has been registered via node S₁, S₂ can process that authentication request in its entirety without any interaction or communication with other nodes. However, this single-node approach quickly falls apart in the case where an adversary is able to take control of any individual node (i.e., S_{corrupted}) because the adversary can thereafter censor clients via S_{corrupted} (resulting in a loss of correctness), impersonate clients via S_{corrupted} (resulting in a loss of security), and mount an offline attack to invert hashed client passwords via S_{corrupted} (resulting in a potential loss of privacy).

To address the foregoing and other similar issues, embodiments of the present disclosure provide a distributed registration and authentication approach that enables nodes S₁, . . . , S_{N} of computing system 104 to process each client registration/authentication request in a collaborative manner. In various embodiments, this distributed approach relies on a threshold secret sharing scheme like Shamir's secret sharing that provides two functions: Share and Reconstruct. The Share function takes as input a secret s and outputs N cryptographic portions or “shares” of s (collectively known as a “sharing” of s and as denoted as [s]). Each share sᵢ in [s] can be distributed to a party in a set of N parties, which allows the parties to carry out various operations on secret s using their respective shares (e.g., secure multiparty computations) while keeping s itself hidden from each party.

The Reconstruct function takes as input the shares created via the Share function and outputs the original secret s. Significantly, this Reconstruct function requires at least T+1 shares in order to reconstruct/reveal s, where T is some threshold number less than N. This guarantees that a coalition of up to T out of the N parties cannot learn secret s by colluding and disclosing their shares of s to each other; instead, a coalition of at least T+1 parties, and thus T+1 shares, are required. For this reason, [s] is sometimes referred to as a “T-out-of-N” sharing of s. In the case of Shamir's secret sharing, each share sᵢ corresponds to a point p(i) on a T-degree polynomial p, with point p(0) being set to s. It is well known that such a T-degree polynomial cannot be uniquely interpolated with less than T+1 points, and thus this construction hides the secret encoded at p(0) from any subset of at most T parties.

In addition to the above, threshold secret sharing schemes are linear in nature, which means that given two sharings [x] and [y] where each party i holds xᵢ and yᵢ, the parties can locally obtain the sharing [z] where z=αx+βy+γ for some arbitrary public values α, β, γ.

With the foregoing explanation of threshold secret sharing in mind, the distributed registration procedure of the present disclosure can generally proceed as shown below. In certain embodiments, this implementation assumes threshold value T is less than N/3, where T is the maximum number of nodes out of S₁, . . . , S_{N} that may be corrupted by an adversary (such that the adversary is able to control the node's internal state and network communications); all network messages passed between client C and nodes S₁, . . . , S_{N}, as well as between the nodes themselves, are secured from tampering and eavesdropping via a mechanism such as Transport Layer Security (TLS); and network 108 is synchronous, which means that if a receiver does not receive an expected network message from a sender within a bounded period of time, the receiver proceeds with its configured processing using a default message containing some predefined value (e.g., zero or null).
1. Client C sends a registration request to nodes S₁, . . . , S_{N} that includes a communication endpoint address (e.g., email address, telephone number, etc.) owned by C
2. Nodes S₁, . . . , S_{N} receive the registration request and generate a T-out-of-N sharing of a random secret value R (i.e., [R]) via a threshold secret sharing scheme; the nodes (or a single node) then send information regarding [R] to client C
3. Client C reconstructs R using the received information, generates a new T-out-of-N sharing of R (i.e., [R′]) via the threshold secret sharing scheme, and sends share R′ᵢ to each node Sᵢ
4. Nodes S₁, . . . , S_{N} securely compute a difference (i.e., delta) between R and R′ using their original shares of [R] and the received shares of [R′] and, for each node Sᵢ, if the delta equals zero, node Sᵢ stores a local registration entry for client C comprising the communication endpoint address and its share Rᵢ of [R]; otherwise, the node takes no action
5. Client C stores R as its authentication credential for logging into system 104

Further, the distributed authentication procedure of the present disclosure can generally proceed as shown below. In certain embodiments, the same constraints/assumptions noted with respect to the distributed registration procedure also apply to this distributed authentication procedure.
1. Client C generates a new T-out-of-N sharing of R (i.e., [R′]) via the threshold secret sharing scheme and sends an authentication request to each node Sᵢ that includes C's previously registered communication endpoint address and share R′ᵢ
2. Nodes S₁, . . . , S_{N} securely compute a delta between R and R′ using the received shares of [R′] and their original shares of [R] and for each node Sᵢ, if the delta equals zero, node Sᵢ outputs a result (e.g., bit value, flag, etc.) indicating that C has been successfully authenticated by that node; otherwise, node Sᵢ outputs a result indicating that C has not been successfully authenticated by that node
3. System 104 grants access to client C if at least N−T of nodes S₁, . . . , S_{N} have successfully authenticated C per the results output at (2)

With these distributed implementations, client registration and authentication can be achieved while advantageously guaranteeing the properties of correctness, security, and privacy. For example, regarding correctness, an honest client will always be able to register and login by virtue of the characteristics of the threshold secret sharing scheme, as long as there are at most T corrupted nodes. Accordingly, an adversary cannot deny service or censor specific clients.

Regarding security, at the time a given client attempts to authenticate/login by submitting a communication endpoint address and a sharing [R′] based on its authentication credential R, if that address was not previously registered with the shares of [R] by nodes S₁, . . . , S_{N}, the delta computed by the nodes at step (2) of the distributed authentication procedure will not equal zero (for example, it may be undefined). Thus, each uncorrupted node will output a result indicating that the client has not been successfully authenticated, thereby denying access to the client.

And regarding privacy, because the original random value R generated at the time of registration is unknown to the nodes, the probability that an adversary guesses R is 1/ [symbol] where [symbol] is the threshold secret sharing scheme's underlying field. With a large enough field, an adversary cannot feasibly guess R. Further, the distributed authentication procedure above makes it impossible to run an offline brute-force attack to guess R, as each guess (which requires the submission of an authentication request) involves processing/interaction by all nodes S₁, . . . , S_{N}. Yet further, in certain embodiments the foregoing distributed registration and authentication procedures can be enhanced such that, at the time of securely computing the deltas at steps (4) and (2) respectively, nodes S₁, . . . , S_{N} can multiply each delta by a fresh random value Q. This enhancement, which is described in greater detail in sections (3) and (4) below, ensures that the nodes cannot learn anything regarding original random value R in the case where the client sends a sharing of a value R′ that is different from R.

### 3. Distributed Registration Workflow

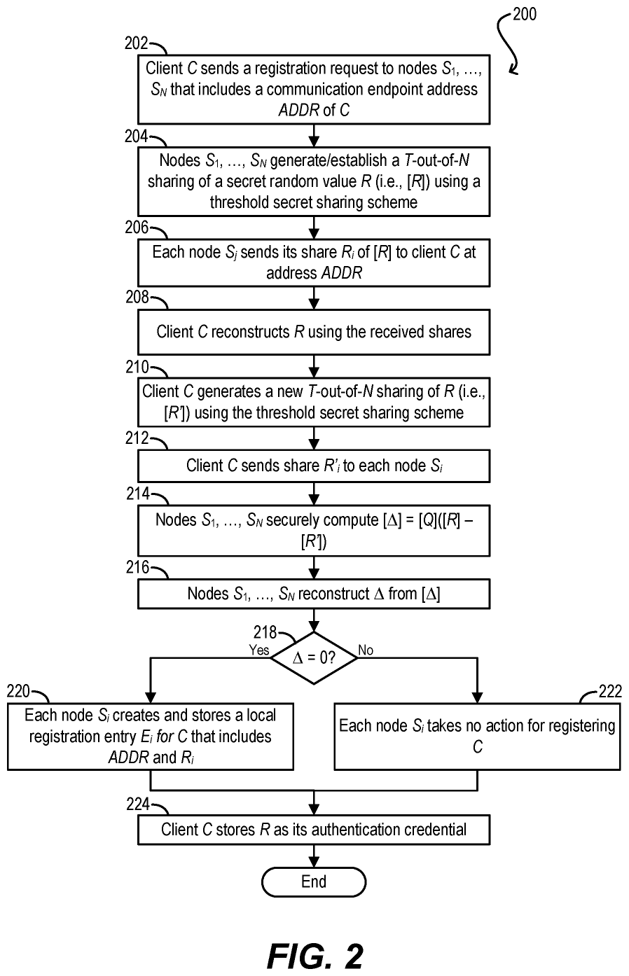

FIG. 2 depicts a workflow 200 that provides additional details regarding the processing that may be performed by client C and nodes S₁, . . . , S_{N} of FIG. 1 for implementing distributed registration via threshold secret sharing according to certain embodiments.

Starting with step 202, client C can send a registration request to nodes S₁, . . . , S_{N} that includes a communication endpoint address ADDR owned by C (or alternatively, owned by a user/individual operating C). This communication endpoint address can be, e.g., an email address, a telephone number, an ID/username associated with a messaging application, or the like.

At step 204, nodes S₁, . . . , S_{N} can receive the registration request and generate/establish a T-out-of-N sharing of a secret random value R (denoted as [R]) via a threshold secret sharing scheme, such that (1) each node Sᵢ holds a share Rᵢ of [R], and (2) no node knows the value of R. For example, in one set of embodiments nodes S₁, . . . , S_{N} can receive their respective shares R₁, . . . , R_{N} from a trusted third-party that invokes the Share function of the threshold secret sharing scheme on R. In another set of embodiments, two nodes (e.g., S₁ and S₂) can create sharings of randomly selected values Y and Z where Y is only known to S₁, Z is only known to S₂, and random value R=Y+Z. Nodes S₁ and S₂ can then distribute the shares of [Y] and [Z] to the other nodes and each node can compute its share of [R] as the sum of its shares of [Y] and [Z]. With this method, no single node will know both Y and Z and thus cannot learn R.

Upon generating/establishing [R], each node S₁ can send its respective share Rᵢ to client C via C's communication endpoint address ADDR (step 206).

At step 208, client C can receive the shares of [R] at ADDR and can reconstruct R (via the threshold secret sharing scheme's Reconstruct function) using the received shares. Client C then generate a new T-out-of-N sharing of the reconstructed value of R (denoted as [R′]) comprising shares R′₁, . . . , R′_{N} (step 210) and can send share R′ᵢ to each node Sᵢ (step 212).

At step 214, nodes S₁, . . . , S_{N} can receive shares R′₁, . . . , R′_{N} and can securely compute, via a secure multiparty computation (MPC) protocol, [Δ]=[Q]·([R]−[R′]), where [Q] is a new sharing of a non-zero secret random value Q that is generated by the nodes for this specific registration request. As mentioned previously, the use of Q in this computation prevents the nodes from learning anything regarding R in the scenario where R′ is different from R and thereby bolsters the privacy of the solution. In alternative embodiments where this additional degree of privacy preservation is not needed, the nodes can simply compute [Δ]=[R]−[R′].

Nodes S₁, . . . , S_{N} can thereafter collectively reconstruct/reveal delta value Δ using their shares of [Δ] (step 216) and each node Sᵢ can check whether Δ=0 (step 218). If the answer is yes (which means R=R′), node Sᵢ can conclude that client C correctly re-shared R at step 208 and thus is the owner of communication endpoint address ADDR. Accordingly, node Sᵢ can create and store a local registration entry Eᵢ for client C that includes ADDR and the node's share Rᵢ of [R] (step 220).

On the other hand, if the answer at step 218 is no, node Sᵢ can conclude that client C is not the owner of the communication endpoint address (or otherwise re-shared a value R′ that is different from R in violation of the registration procedure). In this case, node Sᵢ can take no action for registering client C (step 222).

Finally, at step 224, client C can store R as its authentication credential for logging into system 104 and workflow 200 can end.

### 4. Distributed Authentication Workflow

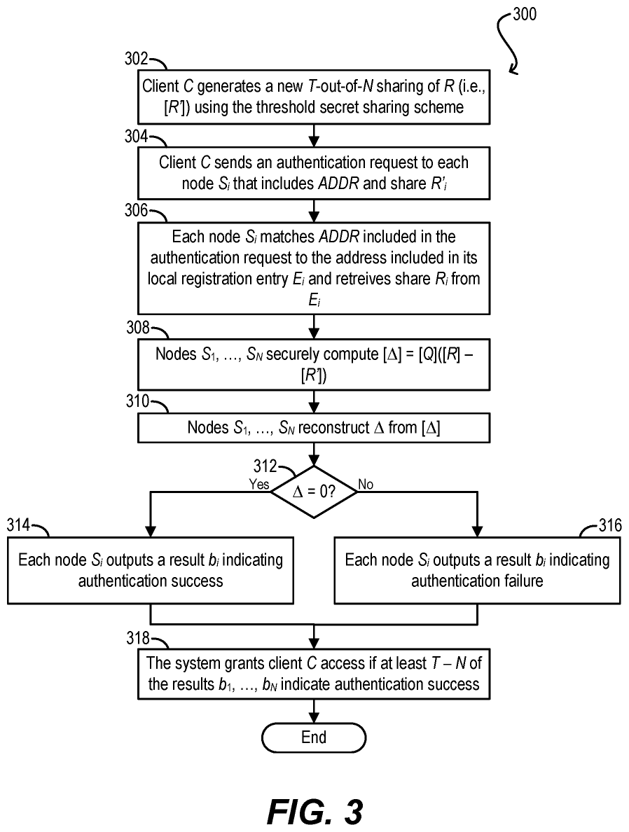

FIG. 3 depicts a workflow 300 that provides additional details regarding the processing that may be performed by client C and nodes S₁, . . . , S_{N} of FIG. 1 for implementing distributed authentication via threshold secret sharing according to certain embodiments. Workflow 300 assumes that client C has registered with system 104 via workflow 200 and thus C holds R and each (uncorrupted) node Sᵢ holds a local registration entry Eᵢ comprising C's communication endpoint address ADDR and that node's share Rᵢ of [R].

Starting with steps 302 and 304, Client C can generate a new T-out-of-N sharing of R (denoted as [R′]) comprising shares R′₁, . . . , R′_{N} and can send an authentication request to each node Sᵢ that includes ADDR and share R′ᵢ. In various embodiments, sharing [R′] is not the same as sharing [R′] described in distributed registration workflow 200; instead, [R′] here is a completely new sharing of R that is created by client C for this specific authentication request.

At step 306, each node Sᵢ can receive the authentication request, match the communication endpoint address ADDR included in the authentication request to the address identified in its local registration entry Eᵢ, and retrieve share Rᵢ from Eᵢ. Nodes S₁, . . . , S_{N} can then securely compute, via an MPC protocol, [Δ]=[Q]·([R]−[R′]) using the shares of R′ included in the received authentication requests and the shares of [R] retrieved from the local registration entries (step 308). As discussed with respect to workflow 200, [Q] is a new sharing of a non-zero secret random value Q that is generated by the nodes for this specific authentication request and is used to obfuscate the true value of [R]−[R] in cases where R≠R′, thereby preventing the nodes from learning anything regarding R.

At steps 310 and 312, nodes S₁, . . . , S_{N} can collectively reconstruct/reveal delta value Δ using their shares of [Δ] and each node Sᵢ can check whether Δ=0. If the answer is yes (which means R=R′), node S₁ can conclude that client C has been successfully authenticated and can output a result bᵢ indicating authentication success (step 314).

On the other hand, if the answer at step 312 is no, node Sᵢ can conclude that client C has not been successfully authenticated. In this case, node Sᵢ can output a result bᵢ indicating authentication failure (step 316).

Finally, at step 318, system 104 can grant client C access if at least N— T nodes have output a result indicating authentication success per step 314 and workflow 300 can end.

### 5. Distributed Registration Workflow Using Additively Homomorphic Encryption

One drawback with the distributed registration workflow shown in FIG. 2 and described in section (3) above that that each node Sᵢ separately sends its share Rᵢ of [R] to client C at step 206. This reduces the usability of the solution in scenarios where N is large because the client must wait for and receive N separate messages from the nodes before it can reconstruct R and proceed with the registration.

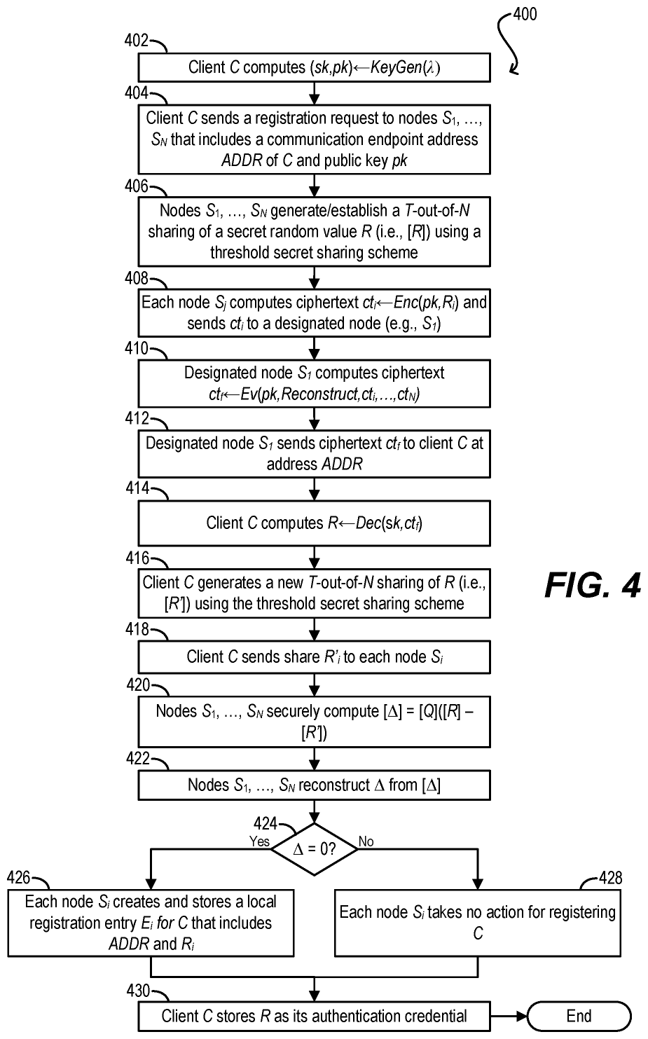

To address this issue, FIG. 4 depicts an alternative distributed registration workflow 400 that leverages additively homomorphic encryption (AHE) according to certain embodiments. AHE is an encryption scheme that comprises the following functions:
1. (sk, pk)→KeyGen(λ): The KeyGen function takes as input a security parameter A and outputs secret and public keys (sk, pk)
2. ct→Enc(pk, pt): The Enc function takes as input a public key pk and a plaintext pt and outputs a ciphertext ct
3. pt→Dec(sk, ct): The Dec function takes as input a secret key sk and a ciphertext ct and outputs a plaintext pt
4. ct_{f}→Ev(pk, f, ct₁, . . . , ctₘ): The Ev function takes as input a public key pk, an m-ary linear function ƒ, and a set of m ciphertexts ct₁, . . . , ctₘ and outputs a ciphertext ct_{f}

Generally speaking, an AHE scheme guarantees that, for any m and every m-ary linear function ƒ, Dec(sk, Ev(pk, f, ct₁, . . . , ctₘ))=ƒ(Dec(sk, ct₁), . . . , Dec(sk, ctₘ)) where (sk, pk)→KeyGen(λ) for some λ and ctᵢ is either the result of Enc(pk;) or Ev(pk, ƒ;). In other words, it doesn't matter whether you (1) first evaluate ƒ on the ciphertexts ct₁, . . . , ctₘ using the Ev function (resulting in ct_{f}) and then decrypt ct_{f} or (2) first decrypt each ciphertext ctᵢ separately using the Dec function (resulting in plaintexts pt₁, . . . , ptₘ) and then evaluate ƒ on pt₁, . . . , ptₘ; the results of (1) and (2) are the same.

This means that instead of having each node Sᵢ send its share Rᵢ to client C, each node Sᵢ can encrypt Rᵢ using an AHE scheme and send the resulting ciphertext ctᵢ to a designated node (e.g., S₁), which maintains the secrecy of the shares from S₁. Designated node S₁ can then compute ct_{f}→Ev(pk, f, ct₁, . . . , ct_{N}) (where ƒ is the Reconstruct function of the threshold secret sharing scheme used to generate [R]) and can send ct_{f} to client C. Client C can thereafter reconstruct R by computing Dec(sk, ct_{f}) because per the properties of the AHE scheme, Dec(sk, ct_{f}) is equivalent to Reconstruct(Dec(sk, ct₁), . . . , Dec(sk, ct_{N})). Accordingly, with this approach, only a single message needs to be received by client C in order to reconstruct R (i.e., the message comprising ciphertext ct_{f} sent from designated node S₁), thereby significantly streamlining the registration process.

Turning now to workflow 400, client C can compute a secret key/public key pair (sk, pk) by invoking the KeyGen function of an AHE scheme (step 402) and can send a registration request to nodes Sp₁, . . . , S_{N} that includes a communication endpoint address ADDR owned by C (or alternatively, owned by a user/individual operating C) and the public key pk. This communication endpoint address can be, e.g., an email address, a telephone number, an ID/username associated with a messaging application, or the like.

At step 406, nodes S₁, . . . , S_{N} can receive the registration request and generate/establish a T-out-of-N sharing of a secret random value R (denoted as [R]) via a threshold secret sharing scheme, such that (1) each node S₁ holds a share Rᵢ of [R], and (2) no node knows the value of R. As mentioned previously, in one set of embodiments nodes S₁, . . . , S_{N} can receive their respective shares R₁, . . . , R_{N} from a trusted third-party that invokes the Share function of the threshold secret sharing scheme on R. In another set of embodiments, two nodes (e.g., S₁ and S₂) can create sharings of randomly selected values Y and Z where Y is only known to S₁, Z is only known to S₂, and random value R=Y+Z. Nodes S₁ and S₂ can then distribute the shares of [Y] and [Z] to the other nodes and each node can compute its share of [R] as the sum of its shares of [Y] and [Z]. With this method, no single node will know both Y and Z and thus cannot learn R.

At step 408, each node Sᵢ can compute ciphertext ctᵢ by invoking the Enc function of the AHE scheme on its share Rᵢ using public key pk (i.e., Enc(pk, Rᵢ) and can send ctᵢ to a designated node (e.g., S₁). In response, designated node S₁ can compute ciphertext ct_{f} by invoking the Ev function of the AHE scheme on the Reconstruct function of the threshold sharing scheme, ciphertexts ct₁, . . . , ct_{N}, and public key pk (i.e., Ev(pk, Reconstruct, ctᵢ, . . . , ct_{N}) (step 410). Designated node S₁ can then send a single message comprising ct_{f} to client C via C's communication endpoint address ADDR (step 412).

At step 414, client C can receive ciphertext ct_{f} at ADDR and can compute R by invoking the Dec function of the AHE scheme on ct_{f} using its secret key sk (i.e., Dec(sk, ct_{f})). Client C can subsequently generate a new T-out-of-N sharing of the reconstructed value of R (denoted as [R′]) comprising shares R′₁, . . . , R′_{N} (step 416) and can send share R′ᵢ to each node Sᵢ (step 418).

At step 420, nodes S₁, . . . , S_{N} can receive shares R′₁, . . . , R′N and can securely compute, via a secure multiparty computation (MPC) protocol, [Δ]=[Q]·([R]−[R′]), where [Q] is a new sharing of a non-zero secret random value Q that is generated by the nodes for this specific registration request. As mentioned previously, the use of Q in this computation prevents the nodes from learning anything regarding R in the scenario where R′ is different from R and thereby bolsters the privacy of the solution. In alternative embodiments where this additional degree of privacy preservation is not needed, the nodes can simply compute [Δ]=[R]−[R′].

Nodes S₁, . . . , S_{N} can then collectively reconstruct/reveal delta value Δ using their shares of [Δ] (step 422) and each node Sᵢ can check whether Δ=0 (step 424). If the answer is yes (which means R=R′), node Sᵢ can conclude that client C correctly re-shared R at step 418 and thus is the owner of communication endpoint address ADDR. Accordingly, node Sᵢ can create and store a local registration entry Eᵢ for client C that includes ADDR and the node's share Rᵢ of [R] (step 426).

On the other hand, if the answer at step 424 is no, node Sᵢ can conclude that client C is not the owner of the communication endpoint address (or otherwise re-shared a value R′ that is different from R in violation of the registration procedure). In this case, node Sᵢ can take no action for registering client C (step 428).

Finally, at step 430, client C can store R as its authentication credential for logging into system 104 and workflow 400 can end.

In various embodiments, workflow 400 assumes that designated node S₁ is semi-honest (i.e., will not actively attempt to sabotage the registration process) and thus will not send an incorrect value for ciphertext ct_{f} to client C at step 412. In addition, workflow 400 assumes that the Reconstruct function of the threshold secret sharing scheme is a linear function. This latter assumption will be true if the threshold secret sharing scheme is, e.g., Shamir's secret sharing.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a set of N nodes in a computing system, a registration request from a client, the registration request including a communication endpoint address and a public key of the client;
generating, by the set of N nodes, a T-out-of-N sharing [R] of a secret random value R using a threshold secret sharing scheme, wherein T corresponds a maximum number of nodes in the set of N nodes that may be corrupted by an adversary;
encrypting, by each node i in the set of N nodes, a share Rᵢ of [R] using an encryption function of an additively homomorphic encryption (AHE) scheme, the encrypting resulting in a ciphertext ctᵢ;
sending, by said each node i in the set of N nodes, ctᵢ to a designated node in the set of N nodes;
computing, by the designated node using an evaluation function of the AHE scheme, a ciphertext ct_{f} based on the public key, a reconstruct function of the threshold secret sharing scheme, and ctᵢ received from said each node i; and
sending, by the designated node, ct_{f} to the client at the communication endpoint address.

2. The method of claim 1 further comprising:
receiving, by said each node i in the set of N nodes, a share R′ᵢ of a T-out-of-N sharing [R′] from the client, wherein [R′] is generated by the client using the threshold secret sharing scheme based on a value R′ computed from ct_{f};
computing, by the set of N nodes using their shares of [R] and [R′], a delta value Δ reflecting a difference between R and R′; and
upon determining that Δ equals zero, storing, by said each node i in the set of N nodes, a registration entry Eᵢ for the client that includes the communication endpoint address and R.

3. The method of claim 2 wherein the client computes R′ by invoking a decryption function of the AHE scheme on ct_{f} using a secret key corresponding to the public key.

4. The method of claim 2 wherein the client stores R as an authentication credential for logging into the computing system.

5. The method of claim 2 wherein the computing of Δ comprises:
computing a sharing [Δ] of Δ based on [R] and [R′] using a secure multiparty computation (MPC) protocol; and
reconstructing Δ from [Δ].

6. The method of claim 2 wherein Δ equals a difference between R and R′ multiplied by a secret random value Q that is unique to the registration request.

7. The method of claim 2 further comprising:
receiving, by said each node i in the set of N nodes, an authentication request from the client, the authentication request including the communication endpoint address and a share R″ᵢ of a T-out-of-N sharing [R″], wherein [R″] is generated by the client using the threshold secret sharing scheme based on R;
matching, by said each node i in the set of N nodes, the communication endpoint address in the authentication request to the previously stored registration entry Eᵢ;
retrieving, by said each node i in the set of N nodes, Rᵢ from Eᵢ;
computing, by the set of N nodes using their shares of [R] and [R″], a delta value Δ′ reflecting a difference between R and R″; and
upon determining that Δ′ equals zero, outputting, by said each node i in the set of N nodes, a result indicating that the client is successfully authenticated.

8. A non-transitory computer readable storage medium having stored thereon program code executable by a set of N nodes in a computing system, the program code embodying a method comprising:
receiving a registration request from a client, the registration request including a communication endpoint address and a public key of the client;
generating a T-out-of-N sharing [R] of a secret random value R using a threshold secret sharing scheme, wherein T corresponds a maximum number of nodes in the set of N nodes that may be corrupted by an adversary;
encrypting, by each node i in the set of N nodes, a share Rᵢ of [R] using an encryption function of an additively homomorphic encryption (AHE) scheme, the encrypting resulting in a ciphertext ctᵢ;
sending, by said each node i in the set of N nodes, ctᵢ to a designated node in the set of N nodes;
computing, by the designated node using an evaluation function of the AHE scheme, a ciphertext ct_{f} based on the public key, a reconstruct function of the threshold secret sharing scheme, and ctᵢ received from said each node i; and
sending, by the designated node, ct_{f} to the client at the communication endpoint address.

9. The non-transitory computer readable storage medium of claim 8 wherein the method further comprises:
receiving, by said each node i in the set of N nodes, a share R′ᵢ of a T-out-of-N sharing [R′] from the client, wherein [R′] is generated by the client using the threshold secret sharing scheme based on a value R′ computed from ct_{f};
computing, by the set of N nodes using their shares of [R] and [R′], a delta value Δ reflecting a difference between R and R′; and
upon determining that Δ equals zero, storing, by said each node i in the set of N nodes, a registration entry Eᵢ for the client that includes the communication endpoint address and Rᵢ.

10. The non-transitory computer readable storage medium of claim 9 wherein the client computes R′ by invoking a decryption function of the AHE scheme on ct_{f} using a secret key corresponding to the public key.

11. The non-transitory computer readable storage medium of claim 9 wherein the client stores R as an authentication credential for logging into the computing system.

12. The non-transitory computer readable storage medium of claim 9 wherein the computing of Δ comprises:
computing a sharing [Δ] of Δ based on [R] and [R′] using a secure multiparty computation (MPC) protocol; and
reconstructing Δ from [Δ].

13. The non-transitory computer readable storage medium of claim 9 wherein Δ equals a difference between R and R′ multiplied by a secret random value Q that is unique to the registration request.

14. The non-transitory computer readable storage medium of claim 9 wherein the method further comprises:
receiving, by said each node i in the set of N nodes, an authentication request from the client, the authentication request including the communication endpoint address and a share R″ᵢ of a T-out-of-N sharing [R″], wherein [R″] is generated by the client using the threshold secret sharing scheme based on R;
matching, by said each node i in the set of N nodes, the communication endpoint address in the authentication request to the previously stored registration entry Eᵢ;
retrieving, by said each node i in the set of N nodes, Rᵢ from Eᵢ;
computing, by the set of N nodes using their shares of [R] and [R″], a delta value Δ′ reflecting a difference between R and R″; and
upon determining that Δ′ equals zero, outputting, by said each node i in the set of N nodes, a result indicating that the client is successfully authenticated.

15. A node in a set of N nodes that collectively make up a computing system, the node comprising:
a processor; and
a non-transitory computer readable medium having stored thereon program code that, when executed, causes the processor to:
receive a registration request from a client, the registration request including a communication endpoint address and a public key of the client;
generate, in conjunction with other nodes in the set of N nodes, a T-out-of-N sharing [R] of a secret random value R using a threshold secret sharing scheme, wherein T corresponds a maximum number of nodes in the set of N nodes that may be corrupted by an adversary;
encrypt a share Rᵢ of [R] using an encryption function of an additively homomorphic encryption (AHE) scheme, the encrypting resulting in a ciphertext ctᵢ;
receive, from the other nodes, other ciphertexts Ctₒₜₕₑᵣ created by the other nodes using the encryption function and the other nodes' shares of [R];
compute, using an evaluation function of the AHE scheme, a ciphertext ct_{f} based on the public key, a reconstruct function of the threshold secret sharing scheme, ctᵢ, and ctₒₜₕₑᵣ; and
send ct_{f} to the client at the communication endpoint address.

16. The node of claim 15 wherein the program code further causes the processor to receive a share R′ᵢ of a T-out-of-N sharing [R′] from the client, wherein [R′] is generated by the client using the threshold secret sharing scheme based on a value R′ computed from ct_{f};
compute, in conjunction with the other nodes, a delta value Δ reflecting a difference between R and R′; and
upon determining that Δ equals zero, store a registration entry Eᵢ for the client that includes the communication endpoint address and R.

17. The node of claim 16 wherein the client computes R′ by invoking a decryption function of the AHE scheme on ct_{f} using a secret key corresponding to the public key.

18. The node of claim 16 wherein the client stores R as an authentication credential for logging into the computing system.

19. The node of claim 16 wherein the program code that causes the processor to compute Δ comprises program code that causes the processor to:
compute a sharing [Δ] of Δ based on [R] and [R′] using a secure multiparty computation (MPC) protocol; and
reconstruct Δ from [Δ].

20. The node of claim 16 wherein Δ equals a difference between R and R′ multiplied by a secret random value Q that is unique to the registration request.

21. The node of claim 16 wherein the program code further causes the processor to:
receive an authentication request from the client, the authentication request including the communication endpoint address and a share R″ᵢ of a T-out-of-N sharing [R″], wherein [R″] is generated by the client using the threshold secret sharing scheme based on R;
match the communication endpoint address in the authentication request to the previously stored registration entry Eᵢ;
retrieve Rᵢ from Eᵢ;
compute, in conjunction with the other nodes, a delta value Δ′ reflecting a difference between R and R″; and
upon determining that Δ′ equals zero, output a result indicating that the client is successfully authenticated.
